(19) United States
(12) Patent Application Publication
(10) Pub. No.: US 2010/0331166 A1
(43) Pub. Date: Dec. 30, 2010

(54) CARBON/SILICON CARBIDE SYSTEM COMPOSITE MATERIAL

(75) Inventors: Kishio HIDAKA, Hitachiota (JP); Kazuya Baba, Hitachi (JP); Makoto Ebihara, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Chemical Company, Ltd.

(21) Appl. No.: 12/825,502

(22) Filed: Jun. 29, 2010

(30) Foreign Application Priority Data
Jun. 30, 2009 (JP) 2009-154761

(51) Int. Cl. C04B 35/565

(52) U.S. Cl. 501/89; 501/90

(57) ABSTRACT

An object of the present invention is to produce a heat-resistant carbon/silicon carbide system composite material having a high density without deteriorating the mechanical properties such as toughness of carbon fiber.

The present invention is a carbon/silicon carbide system composite material comprising a matrix containing a silicon carbide phase; a carbon fiber dispersed in the matrix; and a eutectic alloy phase containing silicon and an element for lowering a melting point of the silicon, wherein the carbon fiber is covered with a cover layer formed of a composite carbide of the silicon and the element.

### CLAIM OF PRIORITY

The present application claims priority from Japanese Patent application serial No. 2009-154761, filed on Jun. 30, 2009, the content of which is hereby incorporated by reference into this application.

### BACKGROUND OF THE INVENTION

1. (Field of the Invention)

The present invention relates to a carbon/silicon carbide system composite material.

2. (Description of Related Art)

Japanese Unexamined Patent Application Publication No. 2003-522709 discloses a method for producing a brake rotor for an automobile by coating carbon fiber comprising short fibers of 5 to 10 millimeters, ring-shaped carbon fiber fabric or felt-like carbon fiber with polyurethane resin, phenolic resin, acrylic resin, paraffin, pitch, polystyrene or the like; thereafter kneading the coated material together with a binder and an additive; then forming the material by putting it in a mold; calcining the material for eleven hours at 1100° C. in a nitrogen or argon gas atmosphere; processing the surface with a diamond tool; and infiltrating silicon (Si).

Japanese Patent Application Laid-Open No. Hei 10-251065 discloses a method for producing a product by using graphite fiber of 0.1 to 5 millimeters; applying prepreg forming under only pressurization to the material produced by infiltrating silicon (Si infiltration); carbonizing the material; thereafter repeating carbon source infiltration and carbonization up to three times; further graphitizing the material; and applying pulverization, blending, forming, carbonization, and silicon infiltration in this sequence to the material block.

### SUMMARY OF THE INVENTION

A carbon/silicon carbide system composite material according to the present invention comprising a matrix containing a silicon carbide phase; a carbon fiber dispersed in the matrix; and a eutectic alloy phase containing silicon and an element for lowering a melting point of the silicon, wherein the carbon fiber is covered with a cover layer formed of a composite carbide of the silicon and the element.

Further, a carbon/silicon carbide system composite material according to the present invention is characterized in that oxygen trapping particles disperse in the matrix.

The present invention makes it possible to provide a carbon/silicon carbide system composite material having enhanced toughness and heat resistance and being excellent in oxidation resistance.

### BRIEF DESCRIPTION OF THE DRAWINGS

FIG. 1 is a perspective view schematically showing a microstructure of a carbon/silicon carbide system composite material according to the present invention.

FIG. 2 is a graph showing the relationship between a composition of eutectic alloys (Al, Ti) for lowering the melting point of Si, and a melting point (a coagulation point).

FIG. 3 is an optical micrograph showing the microstructure of an Si—Al—Ti alloy in the present invention.

FIG. 4 is a graph showing an X-ray diffraction profile of a carbon fiber of standard elastic modulus type (HT) after heated to 1200° C.

FIG. 5 is a graph showing an X-ray diffraction profile of a carbon fiber of standard elastic modulus type (HT) after heated to 1450° C.

FIG. 6 is a perspective view showing a rotor as a brake member according to an embodiment of the present invention.

### DETAILED DESCRIPTION OF THE PREFERRED EMBODIMENTS

Carbon fiber is generally obtained by calcining a precursor such as polyacrylonitrile (PAN) fiber, pitch fiber or the like at 1200° C. or higher for example in an inert atmosphere. Since the elastic modulus of the carbon fiber improves as the calcination temperature of a precursor is raised in the production of the carbon fiber, a temperature range of 1200° C. to 2000° C. is adopted for the purpose of adjusting the elastic modulus that is a parameter of mechanical strength.

Hard acicular carbon fiber has a high elastic modulus but is insufficient in toughness or plasticity however. Consequently, the hard acicular carbon fiber is inadequate since it can hardly follow gradual shape change and is likely to fracture at a corner in case of a shape having a nearly perpendicular corner.

Conventional silicon infiltration is applied in a temperature range of 1450° C. to 1600° C. that is higher than the calcination temperature of a precursor in the production of carbon fiber. Hence the carbon fiber is not influenced by the infiltration temperature as long as the calcination temperature of a precursor is 1600° C. or higher in the production of carbon fiber. However, it is impossible to assure an accurate temperature in a furnace in such a high temperature range as 1600° C. since the silicon infiltration is applied at a very high temperature. A controllable temperature range in a furnace is within 100° C. Here, when the calcination temperature of the carbon fiber is higher than a temperature of the silicon infiltration and the difference between the calcination temperature of the carbon fiber and the temperature of the silicon infiltration is 100° C. or less, the calcination temperature of carbon fiber is called a silicon infiltration process temperature.

A problem to be solved by the present invention is that the silicon infiltration process temperature is too high for carbon fiber obtained by calcination at 1200° C. to 1600° C.

In a carbon/silicon carbide system composite material, flexibility or toughness is an important parameter and the problem can be solved by lowering the silicon infiltration process temperature lower than the calcination temperature, when the calcination temperature of a precursor is 1200° C. to 1600° C. in the production of carbon fiber, which is a problem of the present invention.

In this way, the present inventors have found that the mechanical properties such as the toughness of the carbon fiber deteriorate by applying thermal history at a temperature higher than the calcination temperature of the precursor in the production of the carbon fiber when silicon infiltration is applied.

An object of the present invention is to produce a carbon/silicon carbide system composite material having a high density without deteriorating mechanical properties such as the toughness of carbon fiber by controlling the temperature in the silicon infiltration of the carbon fiber lower than the calcination temperature of the carbon fiber.

The present invention relates to a carbon/silicon carbide system composite material that improves strength in high temperature and toughness by infiltrating a molten eutectic alloy containing silicon (Si) as the main component into carbon fiber.

The present invention is a heat-resistant material containing carbon fiber and an Si—Al eutectic alloy in an SiC phase constituting a matrix; and characterized in that the melting point of the Si—Al eutectic alloy is lower than the calcination temperature of the carbon fiber by 100° C. or more. The present invention is further characterized by having a structure in which Al—Si containing composite oxide particles (composite oxide particles containing Al and Si) disperse finely in an Si—Al eutectic alloy matrix.

### (Outline of Composite Material)

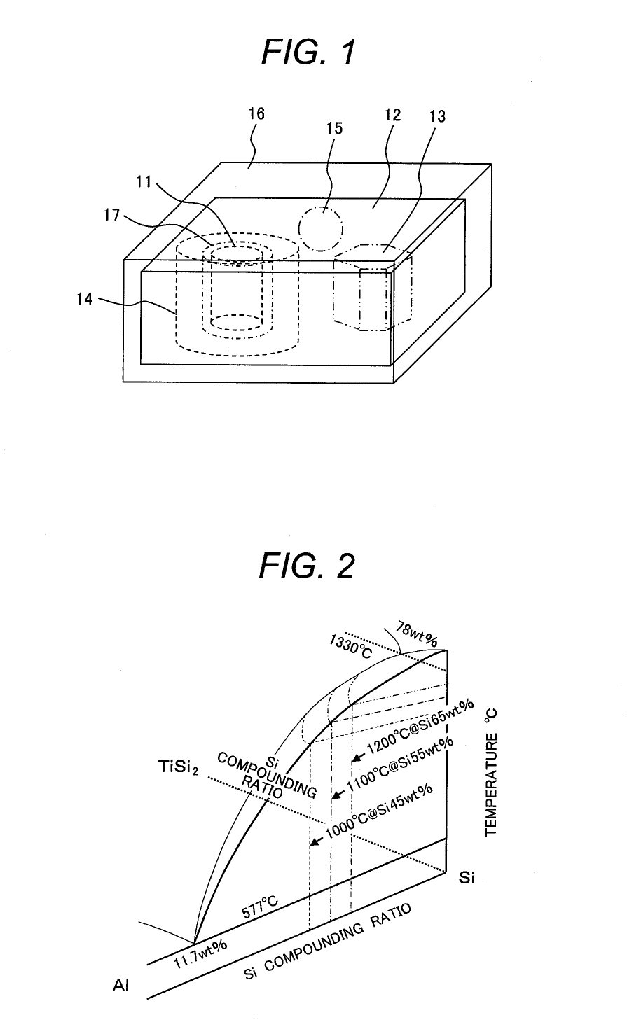

FIG. 1 is a perspective view schematically showing a microstructure of a carbon/silicon carbide system composite material according to the present invention.

As shown in the figure, the microstructure of a carbon/silicon carbide system composite material according to the present invention includes a carbon fiber 11; an SiC phase 12 composed of a silicon carbide; a eutectic alloy phase 13 composed of silicon and an inorganic material that forms a eutectic alloy with the silicon; a cover layer 14 composed of silicon carbide formed by chemically bonding a remaining carbon component derived from resin to silicon or carbide of a eutectic alloy; an oxygen trapping particle 15 comprising a eutectic alloy (TiSi₂ or the like) composed of titanium, chromium, manganese, molybdenum or another and silicon; and an oxygen barrier layer 16 composed of metallic oxide to cover the surface of the composite material. Further, an amorphous carbon layer 17 is formed between the carbon fiber 11 and the cover layer 14.

The purpose of the oxygen trapping particle 15 here is to bond with and capture oxygen intruding and dispersing in the carbon/silicon carbide system composite material; and thereby to prevent the carbon fiber 11 from oxidizing and disappearing. Further, the purpose of the oxygen barrier layer 16 is to block the intrusion of oxygen from the exterior of the carbon/silicon carbide system composite material.

The carbon/silicon carbide system composite material is produced by heating an inorganic material (an infiltration material) to form a eutectic alloy containing silicon (Si) as the main component higher than the melting point; and infiltrating the inorganic material into a carbon composite material formed by dispersing the carbon fiber 11 in resin and carbonizing the resin. Aluminum, gold, silver etc. can be used as the inorganic material to form a eutectic alloy with silicon. Further, titanium, chromium, manganese, molybdenum etc. may be added as a third addition element to the inorganic material. The oxygen trapping particle 15 can be formed by the addition of the third addition element. Here, when titanium is contained as the third addition element in the inorganic material, titanium carbide (TiC) is also formed in the cover layer 14. Further, when chromium (Cr) is contained as the third addition element in the inorganic material, the oxygen barrier layer 16 becomes a stable oxide film containing chromium oxide.

Further, it is desirable that the eutectic alloy (phase) containing silicon as the main component has a face-centered cubic lattice crystal.

When the carbon fiber 11 directly contacts molten silicon and silicon carbide is formed, the material may brittle and the mechanical properties may deteriorate in some cases. For the purpose of preventing the carbon fiber 11 from directly contacting the molten silicon, the amorphous carbon layer 17 (vitreous carbon) is formed on a surface of the carbon fiber 11. Further, the eutectic alloy phase 13 disperses in the SiC phase 12 as an acicular or polytype microstructure of 10 micrometers or smaller. The oxygen trapping particle 15 disperses in the region other than the carbon fiber 11 as a particle of one micrometer or smaller.

### (Production Process of Carbon/Silicon Carbide System Composite Material)

A carbon/silicon carbide system composite material according to the present invention is produced by dispersing carbon fiber in resin; forming the material into a desired shape under pressure; thereafter carbonizing the material in an inert atmosphere; and thereafter infiltrating an inorganic material containing silicon (an infiltration material) having a melting point (also called a coagulation point) of 1200° C. or lower into the material.

When carbon (for example, resin such as resol) for preventing carbon fiber from forming SiC is attached to the carbon fiber, it is desirable to use a spinning method.

It is desirable that the carbon fiber takes the shape of a tape-like bundle formed by bundling 1200 to 2400 fibers and it is also desirable to apply resin coating to the surface of the carbon fiber by dipping the bundle in the resin such as resol from the viewpoint of preventing the carbon fiber from becoming SiC in the succeeding processes.

It is desirable to cut the resin coated carbon fiber into short fibers having 3 to 12 millimeters in length after dried and hardened. A blended composition is obtained by blending the cut carbon fiber with phenol resin. A fiber-reinforced type plastic is obtained by charging the blended composition into a mold and applying compression molding with a pressing machine.

A carbon composite material is obtained by heating the fiber-reinforced type plastic to 900° C. in a nitrogen atmosphere and carbonizing the phenol resin. Final carbonization is applied by heating the carbon composite material to 1150° C. or lower in a nitrogen or argon atmosphere after deaeration in vacuum. A carbon/carbon composite material is obtained through the carbonization processes. On this occasion, the volume contracts by the thermal decomposition of resin and voids of several percent are formed.

Successively, a carbon/silicon carbide composite material according to the present invention is obtained by arraying an Si eutectic alloy (also called an inorganic material containing silicon) in the shape of grains having 1 to 3 millimeters in diameter or aggregates having 10 to 30 millimeters in length on the carbon/carbon composite material so as to pave the upper surface of the carbon/carbon composite material; and applying reactive sintering at 1150° C. or lower in vacuum. On this occasion, the matrix turns to be a silicon carbide phase by chemically bonding Si to carbon in high temperature reaction during the process in which liquid Si penetrates through the voids formed through the carbonization.

By so doing, it is possible to obtain a heat-resistant carbon/silicon carbide system composite material having a high density and a porosity suppressed to 10% or less without deteriorating the mechanical properties such as toughness of the carbon fiber.

As the length of carbon fiber in a carbon/silicon carbide system composite material increases, mechanical properties tend to improve but the uniform distribution of the fiber tends to be hindered and the uniformity of the material strength is gradually hindered in some cases. It is desirable therefore that the average fiber length is 3 to 12 millimeters.

When the length of the carbon fiber is shorter than 3 millimeters, a drawing length of the carbon fiber is insufficient and the material strength may sometimes lower. On this occasion, the drawing length of the carbon fiber is important in a drawing phenomenon called a pullout of the carbon fiber that functions as a strength index in the fracture of a carbon/silicon carbide composite material according to the present invention.

In contrast, when the length of the carbon fiber exceeds 12 millimeters, the fibers are likely to twine each other in the case where a high degree of fiber filling is required, and it is sometimes difficult to disperse the fibers uniformly. On this occasion, since the mechanical properties such as material strength become uneven, the unevenness of strength may sometimes appear.

When the length of the carbon fiber is in the range of 3 to 12 millimeters, the drawing length of carbon fiber at the pullout is secured sufficiently, the twine of fibers scarcely occurs, and hence the uniformity of strength can be secured.

Further, when the quantity of an element (aluminum (Al) etc.) added for lowering the melting point of silicon constituting a eutectic alloy is increased, the melting point of the inorganic material containing silicon lowers considerably. When the element is aluminum, excessive addition of aluminum may sometimes hinder heat resistance, and hence the quantity of added aluminum is desirably 50 wt % or less.

In the infiltration of the inorganic material containing silicon, the upper limit of the temperature is set at a temperature 50° C. lower than the calcination temperature of the carbon fiber. A temperature in infiltrating an inorganic material containing silicon into carbon fiber is hereunder referred to as a silicon infiltration temperature.

FIG. 2 is a graph showing the relationship between a composition of eutectic alloys (Al, Ti) for lowering the melting point of Si, and a melting point (a coagulation point).

As shown in the figure, when the calcination temperature of a precursor is 1400° C. in the production of carbon fiber, it is desirable to set the upper limit of the silicon infiltration temperature at 1350° C. Since the melting point of pure silicon (Si) is 1410° C. to 1430° C., it is necessary to lower the melting point to 1350° C. On this occasion, the quantity of aluminum added to silicon is about 15 wt %. Further, when the calcination temperature of a precursor is 1200° C. in the production of carbon fiber, the upper limit of the silicon infiltration temperature is 1150° C. On this occasion, it is necessary to lower the melting point to 1150° C. Consequently, the quantity of added aluminum is about 40 wt %.

### (Eutectic Alloys Used for Lowering the Melting Point of Silicon)

As shown in FIG. 2, it is necessary to select a metal that lowers the melting point of the silicon by alloying (forming an inorganic mixture) in order to lower the melting point of silicon. This is a type in which the melting point of an alloy lowers as the quantity of added metal increases when two or more kinds of metals are alloyed and is referred to as a eutectic type alloy.

A metal that forms a eutectic alloy by being mixed with silicon is aluminum (Al), gold (Au), silver (Ag) etc., and Al is desirable when a carbon/silicon carbide system composite material is applied to a large member such as a structural material.

As a third additional element, it is desirable to use chromium (Cr) or titanium (Ti) from the viewpoint of excellence in oxidation resistance, but Cr is an element that does not form a eutectic alloy with Si. In the case of Ti, titanium silicide (TiSi₂) the melting point of which is 1540° C. exists in between, and titanium silicide and silicon also form a eutectic alloy.

An advantage in using titanium silicide is that reaction inhibition between Si and carbon caused by oxygen remaining in the aforementioned carbon/carbon composite material can be removed. Cr and Ti have strong affinity with oxygen, can remove the remaining oxygen by forming oxide, and hence can facilitate the forming of SiC in the matrix. As a result, SiC can be formed overall uniformly by high temperature chemical reaction without forming unreacted Si and carbon. The oxide formed on this occasion precipitates as a composite oxide with alumina in the matrix. This is observed as an oxygen trapping particle in a microstructure.

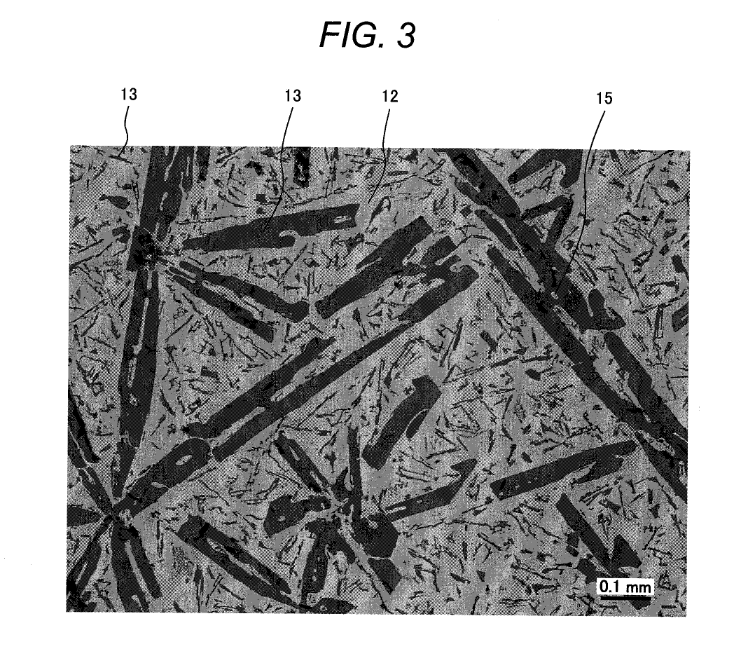

FIG. 3 is an optical micrograph showing a microstructure of an Si—Al—Ti alloy according to the present invention.

The figure is a photograph of an Si—Al—Ti alloy.

In the figure, a eutectic alloy phase 13 covered with an SiC phase 12 and an oxygen trapping particle 15 covered with the eutectic alloy phase 13 are observed. Al—Si containing composite oxide particles (composite oxide particles containing Al and Si) disperse finely in the eutectic alloy phase 13.

### (Carbon Fiber Used for Composite Material)

In carbon fiber, there are a PAN (polyacrylonitrile) type and a pitch type. The carbon fiber is selected in consideration of the balance between a tensile strength and a tensile elastic modulus. Although an elastic modulus and a strength are nearly in a proportional relation, they vary largely and the ranges are different in accordance with the type of carbon fiber. There are a standard elastic modulus type (HT), an intermediate elastic modulus type (IN) and a high elastic modulus type (HM) in the PAN type and there are a low elastic modulus type and an ultra-high elastic modulus type in the pitch type.

The results of the study with a PAN type carbon fiber are that HT is calcined at 1200° C. and has tensile strength ranging from 2.5 to 5.0 GPa and tensile elastic modulus ranging from 200 to 280 GPa; IM is calcined at 1500° C. and has tensile strength ranging from 3.5 to 7.0 GPa and tensile elastic modulus ranging from 280 to 350 GPa; and HM is calcined at 2000° C. or higher and has tensile strength ranging from 2.5 to 5.0 GPa and tensile elastic modulus ranging from 350 to 600 GPa. Carbon fiber having better mechanical properties shows a higher strength. The improvement in the mechanical properties of the carbon fiber is influenced largely by the difference of the calcination temperature of the carbon fiber. Although HM the calcination temperature of which is 2000° C. or higher does not fall under the category of the present invention since the calcination temperature is far higher than the silicon infiltration process temperature, HT and IM fall under the category of the present invention. The silicon infiltration process temperatures for HT and IM are desirably 1100° C. or lower and 1300° C. or lower respectively, and in order to realize those it is necessary to lower the silicon infiltration process temperature by adding Al that effectively lowers a melting point to silicon. Consequently, on this occasion, the quantity of Al added to an inorganic material containing silicon is desirably 20 to 50 wt %.

### (Deterioration Phenomenon of Carbon Fiber)

Strength obtained when HT is used as carbon fiber and an inorganic material containing silicon is infiltrated at 1450° C. is studied. Pulled-out carbon fiber is scarcely seen on a fractured plane in tensile test and there is a possibility of embrittlement. Embrittlement is a phenomenon that carbon bonding changes to graphite bonding, thereby the elastic modulus increases and a high elasticity is obtained and the cavitation of atom sites (hereunder referred to as void forming) caused by releasing bonding with elements such as hydrogen and nitrogen that have bonded at the time of carbon bonding advances simultaneously, when the carbon fiber is heated higher than the calcination temperature of a precursor in the production of the carbon fiber.

High elasticity means that the carbon fiber hardens and also means that the carbon fiber becomes brittle. In particular, since the void forming gives notch effect to carbon fiber, notched portion of the carbon fiber fractures easily and cracks propagate during the propagation of the cracks generated in an inorganic material by tensile test, and hence the pullout of the carbon fiber as a strength factor does not occur. This result can be easily estimated from the fact that the number of carbon fibers that have been pulled out at a fractured plane in the aforementioned tensile test is very few.

In summary, the carbon bonding changes to the graphite bonding in the carbon fiber and voids are formed at the same time, when the silicon infiltration process temperature is higher than the calcination temperature of the precursor in the production of carbon fiber. In other words, carbon fiber itself hardens and simultaneously brittles while notches are formed on the surface thereof. Consequently, it is possible to evaluate the embrittlement by examining the increase of the graphite bonding in the carbon fiber.

The increase of the graphite bonding can be evaluated easily by X-ray diffraction. In X-ray diffraction, carbon bonding is amorphous, hence does not have lattice spacing at a specific Bragg angle, and shows a broad profile. In contrast, the graphite bonding has lattice spacing of 0.34 nm and hence the Bragg angle shows a specific peak corresponding to the lattice spacing in a profile. The embrittlement of the carbon fiber may be evaluated by evaluating the increase of the graphite bonding caused by giving thermal history simulating a silicon infiltration process temperature to the carbon fiber.

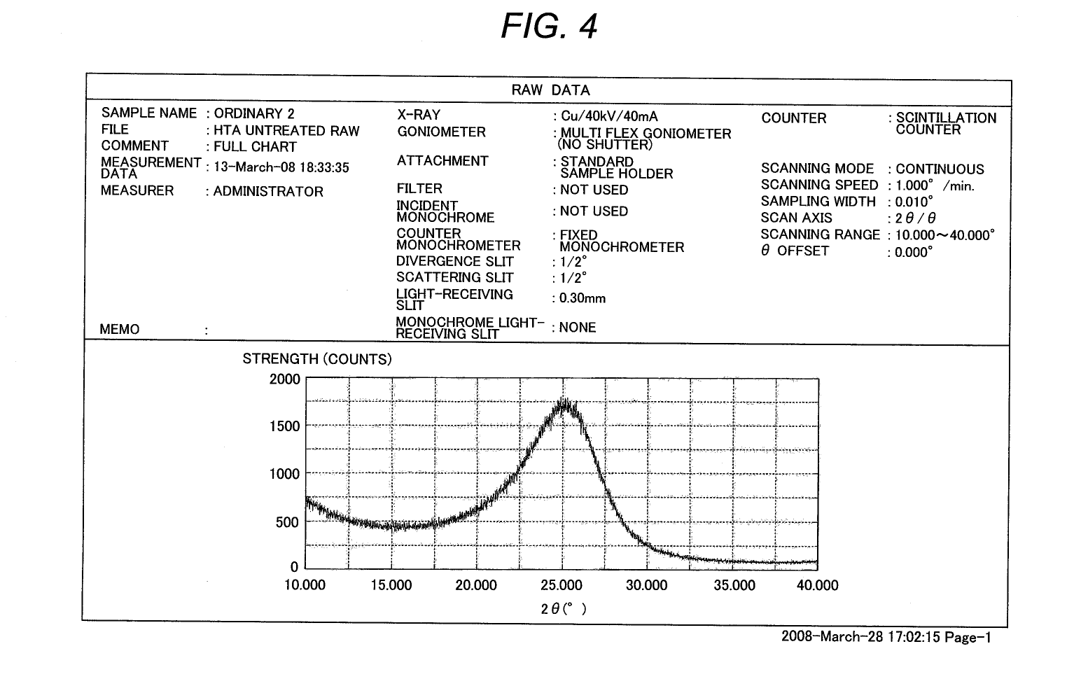

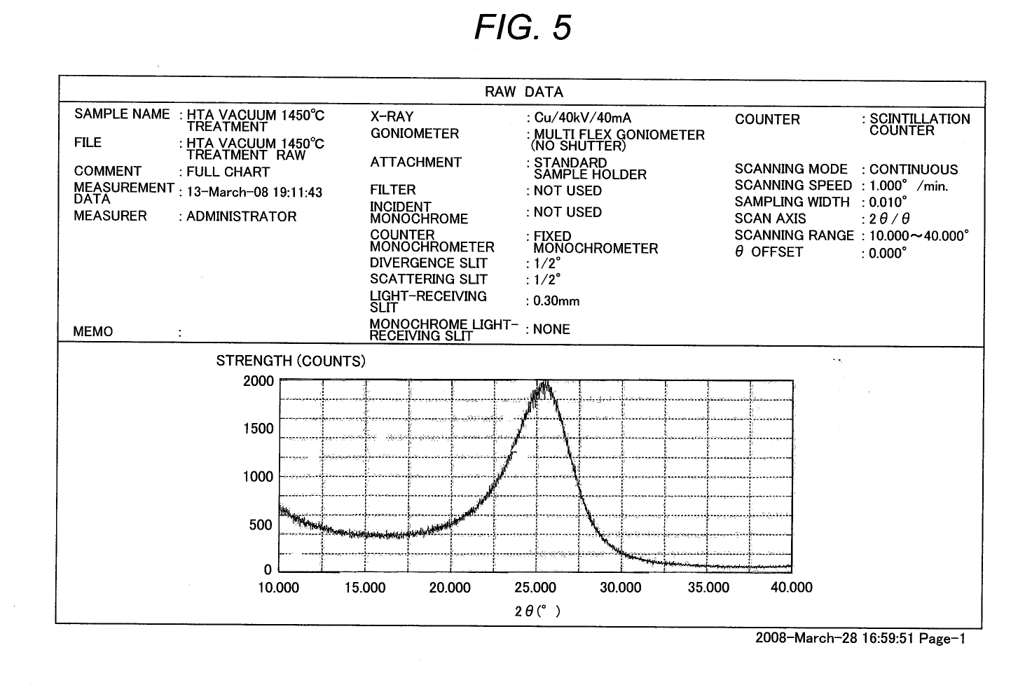

To this end, an embrittlement mechanism of the carbon fiber is investigated. FIGS. 4 and 5 are the results.

FIG. 4 is a graph showing an X-ray diffraction profile of a carbon fiber of standard elastic modulus type (HT) after heated to 1200° C. and FIG. 5 is a graph showing an X-ray diffraction profile of a carbon fiber of standard elastic modulus type (HT) after heated to 1450° C.

As shown in those figures, by comparing the X-ray diffraction results showing the crystal states of fibers in cases of being heated to 1200° C. and 1450° C., it is understood that the reach of a peak narrows as a heating temperature rises; the location shifts; and the quantity of graphite having a lattice spacing of a loose amorphous carbon bonding reduces and the quantity of graphite having a lattice spacing of 0.34 nm increases. Consequently, it is estimated that the graphitization of HT starts, HT hardens, and that the hardening of HT leads to embrittlement because HT is subjected to Si infiltration at 1450° C. in excess of a calcination temperature of 1200° C.

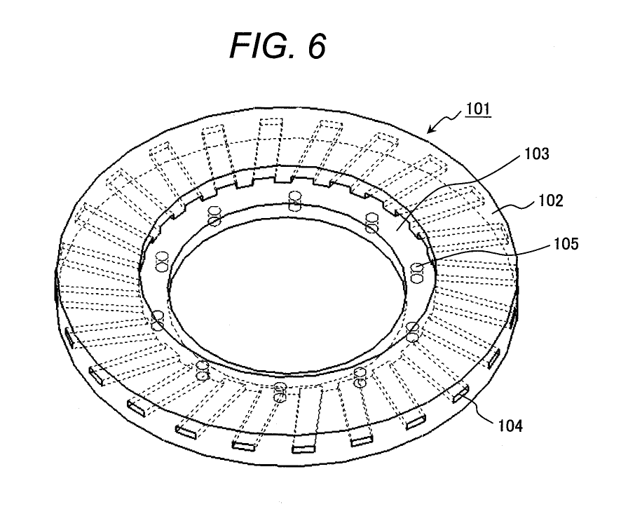

FIG. 6 is a perspective view showing a rotor (a disc) as a brake member according to an embodiment of the present invention.

A rotor for a brake requires high degrees of heat resistance and wear resistance.

A planar portion 102 of a disc 101 is composed of a carbon/silicon carbide system composite material according to the present invention. The purpose of holes 104 is to pass air by centrifugal force and cool the disc 101 when the disc 101 rotates. Further, bolt holes 105 are formed at an annular portion 103 on an inner side of the disc 101 so as to be able to fix the disc 101 to the rotation axis of the disc 101.

The carbon/silicon carbide system composite material according to the present invention is not limited to the application to a rotor stated above and can be applied also to another brake member, a heat-resistant panel, a heat sink, and others.

The present invention makes it possible to prevent the embrittlement caused by the graphitization of the carbon fiber and the deterioration in the toughness of the carbon fiber since the calcination temperature of a precursor is higher than the melting temperature of Si—Al eutectic in the production of the carbon fiber.

Further, the present invention makes it possible to exhibit the effect of preventing the carbon fiber from being oxidized; and prevent the deterioration of the carbon fiber caused by high temperature oxidation since an oxide film comprising aluminum oxide is formed on the surface of a material. Furthermore, since it comes to be possible to form a stable chromium oxide film on a surface by adding chromium (Cr) as the third element, it is possible to improve oxidation resistance.

What is claimed is:

1. A carbon/silicon carbide system composite material comprising:
a matrix containing a silicon carbide phase;
a carbon fiber dispersed in the matrix; and
a eutectic alloy phase containing silicon and an element for lowering a melting point of the silicon,
wherein the carbon fiber is covered with a cover layer formed of a composite carbide of the silicon and the element.

2. The carbon/silicon carbide system composite material according to claim 1, wherein oxygen trapping particles is dispersed in the matrix.

3. The carbon/silicon carbide system composite material according to claim 1, further comprising an amorphous carbon layer between the carbon fiber and the cover layer.

4. The carbon/silicon carbide system composite material according to claim 1, wherein the element is aluminum.

5. The carbon/silicon carbide system composite material according to claim 1, wherein the cover layer contains titanium carbide.

6. The carbon/silicon carbide system composite material according to claim 1, wherein a surface of the matrix is covered with an oxygen barrier layer composed of a chromium oxide film.

7. The carbon/silicon carbide system composite material according to claim 1, wherein a melting point of the eutectic alloy phase is lower than a calcination temperature of a precursor in the production of the carbon fiber.

8. The carbon/silicon carbide system composite material according to claim 1, wherein the eutectic alloy phase has a face centered cubic lattice crystal.

9. A brake member comprising the carbon/silicon carbide system composite material according to claim 1.

10. A heat-resistant panel comprising the carbon/silicon carbide system composite material according to claim 1.

11. A heat sink comprising the carbon/silicon carbide system composite material according to claim 1.

12. A method for producing a carbon/silicon carbide system composite material comprising a matrix containing a silicon carbide phase; a carbon fiber dispersed in the matrix; and a eutectic alloy phase containing silicon and an element for lowering a melting point of the silicon,
the method comprising the steps of:
forming a carbon composite material by dispersing the carbon fiber in a resin and applying a pressure forming and thereafter carbonizing the resin by heating; and
melting an inorganic material to form the eutectic alloy phase at a temperature lower than a calcination temperature of a precursor in the production of the carbon fiber and infiltrating the inorganic material into the carbon composite material.

13. The method according to claim 12, wherein the element is aluminum.

14. The method according to claim 12, wherein the inorganic material containing at least either chromium or titanium.
